(19) United States
(12) Patent Application Publication
(10) Pub. No.: US 2009/0229598 A1
(43) Pub. Date: Sep. 17, 2009

(54) METHOD FOR MAKING LARGE-SIZED HOLLOW CERAMIC PLATE

(76) Inventors: Shuliang Cao, Jinan (CN); Jianhua Xu, Jinan (CN); Bin Cai, Jinan (CN); Qichun Wang, Jinan (CN); Yanling Shi, Jinan (CN); Jianli Xu, Jinan (CN); Shengli Gu, Jinan (CN); Yuguo Yang, Jinan (CN); Dapeng Xiu, Jinan (CN)

Correspondence Address: VENABLE LLP, P.O. BOX 34385, WASHINGTON, DC, 20043-9998, US

(21) Appl. No.: 12/302,489

(22) PCT Filed: May 22, 2007
(86) PCT No.: PCT/CN2007/001653

§ 371 Date: Nov. 25, 2008

(30) Foreign Application Priority Data
May 25, 2006 (CN) 200610044299.6
Jun. 20, 2006 (CN) 200610044930.2
Jul. 5, 2006 (CN) 200610045289.4
Sep. 29, 2006 (CN) 200610068666.6
Dec. 9, 2006 (CN) 200610068789.X
Mar. 8, 2007 (CN) 200710013767.8
Mar. 15, 2007 (CN) 200710013392.5
Mar. 22, 2007 (CN) 200710014008.3
Mar. 27, 2007 (CN) 200710013863.2
Aug. 5, 2007 (CN) 200710014626.8

(51) Int. Cl. F24J 2/20; C04B 38/00; B28B 19/00; F24J 2/34; F24J 2/48

(52) U.S. Cl. 126/617; 264/601; 428/34.4; 126/634

(57) ABSTRACT

A method for making large-size hollow ceramic plate (1, 2, 4) adopts raw materials of ordinary ceramics, mixing with industrial wastes or crude minerals abundant in period IV transition metal elements, squeezing a molded body by vacuum squeezing machine then producing at low cost a large-size hollow ceramic plate (1, 2, 4) with black or fuscous surface or whole body, with an area more than 0.5m² of a single plate. A large-size hollow ceramic plate array (23) is composed of porous ceramic plates (1), through-hole ceramic plates (2) and accessories by gluing or thread-connecting or is composed of seal ceramic plates (4) by series connecting, which can be used in a solar water heater, a solar roof and wall, a generator with large-scale solar wind duct, a large-area solar collector, a far infrared radiation plate and a radiator for construction.

### BACKGROUND OF THE INVENTION

1. Field of the Invention

The present invention relates to technical field of ceramic manufacturing and application of ceramic products thereof, more specifically, to manufacture of a large-sized hollow ceramic plate having black or fuscous surface or as a whole with low cost and long lifetime using industrial wastes, natural minerals, compound abundant in period IV transition metal elements and normal raw ceramic material. The large-size hollow ceramic plate can be used as a solar collecting plate, a far-infrared radiation plate, which can be used in a solar water heater, a solar roof, a solar wall, a solar wind duct, a solar collecting field and a far-infrared radiator for drying and construction.

2. Description of the Related Art

With 200 years continuous accelerating mining, coal, petroleum, natural gas etc. become gradually exhausted. Presently, it is preferable to finding substitutable energy on a large scale within a limited time. Enormous application of solar energy heat collectors with low cost and long lifetime, just the same as nuclear fusion, combustible hydrate in deep sea, solar power station in space and solar battery with low cost etc., can also be used as a substitutable energy on a large scale.

Presently, it is a common understanding in science that the total solar radiating energy arriving to terrestrial surface of the earth is about several tens of thousand times than all of the energy consumed on earth. However, if there is breakthrough in technology and the cost is competitive, solar energy can meet most energy requirement of human being.

In other word, we have to select districts abundant of solar energy, solar energy collectors with low cost can be laid on an area of about millesimal terrestrial surface of the earth, which is about 150 thousand square kilometers, and the collected solar energy is transformed into electricity or other energy form which can be conveniently applied to form substitutable energy on a large scale. And 150 thousand square kilometers equal to 150 billion square meters.

Presently, there mainly exists solar photovoltaic generation and solar thermal generation. And the solar thermal generation can be further classified into higher temperature generation in a condensing, tracking manner and lower temperature generation in collector form. The sunlight collector for photovoltaic generation is solar battery. The collector for high temperature generation is reflector and solar tracking system. The collector for lower temperature generation mainly is plate piped metal collector and vacuum glass pipe. Presently, the disadvantages of the collectors are high cost and short lifetime. Normally the cost thereof may reach hundreds of thousands of RMB per square meter with life time of 5-20 years. Every generator set is mature with fixed cost and life time. However, solar energy is power source with a low density with maximum limit of 1 kw per square meter. Regardless of the precise, complicated and advanced collectors that may be used, they can not collect more energy. Therefore, solar energy collection needs a collector with huge area. And the cost for solar generation mainly is determined by collectors, and the key points relate to the cost, lifetime and efficiency of the collector. Generally, the cost for conventional collector should be reduced by several times whereas the lifetime should be prolonged by several times. Thus, in the near future, solar generation is competitive compared with conventional energy source.

Solar water heater is classified into integral type and thermosyphon type, the thermosyphon type has a higher efficiency with the thermal collecting body mainly adopting metal pipe plate type and vacuum glass pipe type. The metal pipe plate type collector is also called as a flat plate collector. Both have the following disadvantages:

1. the metal pipe plate type collector mainly adopts copper, aluminum etc., and the structure and manufacturing process of the vacuum glass pipe are relatively sophisticated, the prices thereof are relatively high for the thermal absorbing area per square meter.

2. both adopt black sunlight absorbing coating material coated in low temperature, and there is aging in the sun for a long time, which may lead to attenuation of absorptivity, the metal can be easily eroded, the vacuum rate in the vacuum glass pipe decreases gradually, these are the main reasons for problems relating to life time and efficiency.

For the diverse, thin and lower-density solar energy whereas in huge amount, it can only become a substitutable energy source on a large scale if there is a technical breakthrough to find material, structure and application form with more cheap, longer lifetime and higher efficiency so that the solar energy can be used economically, effectively and widely.

The building area of China is about 40 billion square meters with roof areas of about 10 billion square meters, and each year, there is an increase of building area of 2 billion square meters with 0.5 billion square meters of roof area. In addition, there is larger area of wall surfaces facing toward sun, the energy for building is enormous, mainly for summer and winter air conditioning and daily used hot water etc. However, the fossil energy is exhausting, and the adequate use of reproducible energy is a tendency. If the solar energy is used on a large scale, the roof, wall etc. located near human beings should be firstly used for absorbing solar energy economically. And the absorbed solar energy should be firstly used for the energy consuming projects in living rooms and working spaces, such as air conditioning, warming and water heating in addition to for cooking, for appliance and for illumination. The already existed solar roof and solar house can supply 50-80% energy in the living room by solar energy, even to an extent of autarky. However, these experimental solar roof and solar house are erected on conventional art, and the conventional energy consumed during construction and the lifetime may even go beyond the solar energy absorbed therebetween.

The latest developed absorption type air conditioner can transfer the energy of hot water with 65° C. to produce cold wind with 25° C. for summer air conditioning. And the hiemal sunlight can heat the air in the solar collector to 30° C. or above for warming. The solar energy is unstable and low-density energy. The roof area per house in Chinese city is about 15 square meters, with country about 100 square meters, and the wall areas facing south are about 12 square meters and 40 square meters respectively. Presently the areas thereof are increasing rapidly. If the solar energy is used for summer air conditioning and hiemal warming, a solar collector with low cost, longer lifetime and higher efficiency, which can also be easily integrated with buildings, should be provided.

In recent years, some countries undertake experimental researches called as “solar chimney” for solar thermal generation. The solar chimney generation system is mainly composed of chimney collector (a planar greenhouse), a generator and energy storage device. And the air heated by the greenhouse passes through the center of the greenhouse and the bottom of the chimney to produce air flow, thus generating electricity by the generator. In 1982, German researchers erected an exemplary solar chimney project with 50 KW at Manzanaries, south of Madrid, Spain, which puts the concept of generating by turbine driven by large greenhouse hot air flow into practice for the first time. Then, based thereupon, it is planned by Eviro Mission Ltd. To construct a solar chimney generation station with 200 MW in a place 600 km western to Sidney, Australia. The chimney thereof is about 1000 m high with a diameter of 130 m located at the center of a planar green house with a diameter of 7000 m. the core technology relates to create a temperature difference inside and outside of the chimney so that the air in the large circular glass greenhouse is directed to the central slanted ceiling to an air flow with an approximately stable speed. And it is generated by 32 close-typed turbine installed at the bottom of the chimney day and night, and the investment amounts to 1.6-2 billion Australian dollars. The characteristic of the way lie in that there is no condensating system which can not only utilize diffused light but also avoid other questions relating to condensation. The design efficiency is 1.38%, and the designer deems that the generation cost thereof may lower than the generation cost using the relatively cheap coal in Australia.

“Solar chimney” collects heat by planar greenhouse. However, there are following disadvantages by the ascending air flow in the tall chimney and the wind flow created by the pressure difference at the entry and exit ports:

1. Normally, there is a temperature difference of 30° C. inside and outside of the greenhouse, when the solar collector is stagnated, the temperature difference inside and outside may exceed 120° C. Compared therewith, the thermal collecting efficiency of the “solar chimney” is relatively low. However, the existing solar collector is expensive, in which the vacuum glass pipe thermal collecting body is a blind tube with an end blocked which is hard for air flow unobstructed in addition to practical application difficulties.

2. The chimney with a diameter of 130 m and a height of 1000 m is the highest man-made building, and the technology and constructing difficulty during constructing process may bring high cost.

The typical low temperature generation may refer to geothermal power generation. And the cost of geothermal power generation may approximate to thermal power generation which is a conventional energy. And geothermal power generation can be classified into geothermal steam electric generation and geothermal water electric generation. In recent years, the geothermal power generation has developed in generating from hot water with 90° C. to about 70° C., and lower temperature generation is becoming mature technology.

The geothermal steam electric generation can be classified into once steaming method and twice steaming method. The once steaming method directly uses the dry saturation steam or slightly overheated steam underground, or steam separated from the mixture of steam and water for generating power. The twice steaming method has two meanings: first, it means that the dirt natural steam (primary steam) gasifies pure water by passing through heat exchanger rather than directly utilized, then pure steam (secondary steam) is used for generating power, so that the erosion and fouling of the natural steam to the turbine can be avoided. For avoiding erosion and pollution of geothermal fluid to the environment, a dual circulating generation system can be used, such as an isobutene and Freon turbine. After the geothermal fluid with high temperature is pumped into the heat exchanger for evaporating the isobutene, it is directly filled back underground: the isobutene is circulating through the heat exchanger, turbine and the condenser. The second meaning relates to that the hot water with high temperature separated from the primary steam and water is depressurized and dilated to generate secondary steam with pressure still higher than local atmospherical pressure, and the secondary steam enters into the turbine with the primary steam respectively.

It is not convenient to generate power using underground hot water as that using geothermal steam, since the steam itself is the thermal carrier and working fluid when steam is used for electric generation. Compared therewith, the water in the geothermal water can not be directly sent into the turbine for work as in a conventional generation method, it has to be transferred into the turbine for work in a steam state. Presently, for underground hot water electric generation with temperature of 70-100° C., there are two methods: one is depressurizing and dilating method in which the underground hot water entering into a dilator by a vacuum pumping device is depressurized into steam, generating a dilating steam with pressure lower than that of the atmosphere, then the steam and the water is separated, the water is drained out, and the steam is filled into the turbine for doing work, and the system is called “flash steaming system”. The specific volume of the steam with low pressure is large, thus the unit capacity of the turbine is greatly limited. In addition, the method thereof still has fouling problem. However, the generation by depressurization and dilation has a safe running process whereas the capacity of the generator set is low. For the reasons above, there still exists 2 small scaled power stations with unit capacity of 300 KW in China, using hot water of 80-92° C. for generation. The other method uses material with low boiling point, such as intermediate medium for generation of ethyl chloride, normal butane, isobutane and Freon etc. The underground hot water is heated by a heat exchanger so that the material with low boiling point can be rapidly gasified. And the generated gas enters into the generator for doing work. And the medium after doing work is drained into the condenser for being cooled by a cooling system and being circulated after condensating into liquid medium. The method thereof is called as “intermediate medium method”, and the system is called as “a dual flow system” or “a dual medium generating system”.

From 1904 when the first geothermal experimental power station is constructed in Ladarelo, Italy, other countries lagged behind and only developed geothermal generation after 60 s in 20^{th} century. In addition to Italy, there are only 4 countries undertaking geothermal electric generation, i.e. New Zealand, United States and Mexico in 1966 with total capacity of 385.7 MW. However, the number is increased to 6 in 1969 with newcomer of Japan and former Soviet Union with a total capacity of 673.35 MW. And the countries increased to 13 in 1980 including China with a total geothermal generation capacity up to 2885.8 MW. In 1987, the capacity thereof increased to 5004 MW, and in 1999, there are 20 countries having geothermal generation production base with an installed capacity increasing to 7974.06 MW.

The geothermal generation power is varied accordingly which is normally 0.04$/kilowatt-hour (KWH), which is approximately 0.3 RMB. And the Iceland has the lowest generation cost, with 0.02$/KWH.

Although the geothermal generation develops rapidly, the installed capacity all over the world is only about 8000 MW which is no more than a large water-power plant. The development of total installed capacity of geothermal generation is only limited by the following factors:

1. There are rare districts on terrestrial surface with geotherm being exposed, in addition, the districts have already been developed.

2. The exploiting cost for deep layer geotherm is high, and the success rate for well drilling is low.

3. The wells drilled always go beyond 1000 m, and the cost is increased since 100% recirculation should be achieved to maintain productivity and to protect environment.

4. Normally, the geotherm fluid is erosive, and is easy for fouling, thus increasing operation cost and equipment cost accordingly.

There are many energy-consuming drying processes in coating industry, food industry, textile industry, printing industry and grain drying etc. And the drying processes mainly remove the water content and organic volatile matters in the products thereof to accelerate vibration of molecules and moving speed thereof, increasing kinetic energy until they escape to remove thereof. Thermal drying gradually heats the product from external to internal with the shortcomings of low efficiency and tendency of film-forming on surfaces of the products, and the inner volatile matters penetrate through the surface film to be removed. However, the surface may create bubbles and air holes, which may bring quality issues. Far-infrared rays has a certain penetrating capability for organics which may increase temperature both inside and outside that is favorable for the removal of the inner water content and organic volatile matter. And this increases efficiency and product quality. The far-infrared rays means the rays having a wavelength within a range of 2.5˜25μ. Presently, far-infrared heaters utilize elements of silicon carbide with surface being coated with far-infrared coating layer, infrared lamp and quartz glass tube, which all have high prices. And infrared coating layer normally has a radiance of 0.83-0.95, which decreases after longtime usage. And the coating layer is prone to be scaled off, thus polluting the items being dried. The heating body of the infrared lamp has a higher temperature, and the wavelength thereof is close to near-infrared. The energy distribution of the quartz glass tube concentrates relatively, which may influence the university for a number of objects being dried.

Indoor warming mostly uses metal radiators, which is also called as heating radiator, that is installed beside a wall or under a window. The radiator radiates heat when it is heated by medium. Except a little of the thermal energy being dissipated through radiation or by air conduction, most thermal energy is transferred to parts of the indoor space through the uprising heat air flow which drives indoor air into convective circulation, however, this also may lead to dust on or near the ground and the bacteria carried in the dust to be scattered in heights in the room, which may easily suctioned by human body and bring negative influence. Therefore, it is brought forward that the thermal energy of the radiator should adopt infrared radiation rather than convection or conduction. In addition, far-infrared radiation can promote human blood circulation which is favorable to human body. Thus, it is brought forward to make the most of far-infrared radiator. However, the infrared coating material is expensive, prone to be scrapped off, it is not accepted widely. Formerly, the radiator mostly uses cast iron one, however, due to the inferior working condition, grotty appearance and large occupation of land, the production thereof decreases gradually. And taking the place thereof, a hollow steel radiator is used with coatings and patterns of all kinds on the surface thereof, a single panel thereof has a thin thickness with less area occupation. But, steel material, especially welding is strongly eroded by hot water therein. Therefore, erosive resistant coatings having strong adhesive force or bonding force are ejected into inner chamber of the heat dissipating plate covering inner surface thereof to prolong the life time of the steel heat dissipating plate. However, due to the complicated structure thereof, the covering can not be done in a rigorous and persistent way. And the service life of the steel heat dissipating plate presents a dilemma. Further, copper heat dissipating plate has a high cost.

The absorption and emission of sunlight relate to conditions of outer electron in material. The solar coating layer, far-infrared radiation coating layer normally adopted are mostly black, and are composed of period IV transition elements. Due to manufacturing method, sunlight absorptivity and far-infrared radiance are prone to be attenuated, bringing impact to life time and efficiency. Ceramic is mineral with high bonding energy, thus it is stable. However, the former black porcelain has to add period IV transition metal elements such as Co, Cr, Ni, Mn, Fe etc, which are expensive. For a long time, manmade Co series ceramic black colorant has to be strictly formulated, with fine and complicated manufacturing to obtain color stable ceramic black colorant normally sold at 200 thousands RMB per ton.

Chinese invention patent CN85102464, titled “manufacturing method of raw material for black porcelain product and product thereof”, CN86104984 titled “ceramic powder” filed and granted to the present inventor discloses a method for manufacturing all kinds of black porcelain products using tailings of vanadium extraction as one of raw materials, the black porcelain is called as vanadium-titanium black porcelain. The invention is filed with a title of “ceramic powder and articles made therefrom” which is granted in 9 foreign countries, i.e., U.S. Pat. No. 4,737,477 in U.S., No. 1736801 in Japan, No. 0201179 in EPO, No. 578815 in Australia, No. 1009/91 in Singapore, No. 81336 in Finland and No. 1077/1991 in Hongkong. In later 80 s of 20^{th} century, the present inventor submitted related patents “solar tile of black porcelain”, “solar collector of black porcelain blocking plate type”, “solar roof of black porcelain”, “solar collecting box of black porcelain”, “solar tile of black porcelain having joint interface”, “solar far-infrared water boiler of black porcelain”, “ceramic water storage tank”, “compound cement board”, “infrared element of ceramic sleeve type”, “black porcelain infrared chair” etc.

During May 25, 2006 to May 8, 2007, the present inventor submitted Chinese invention patents “manufacturing method of compound ceramic hollow solar collector”, “structure and material of novel solar roof”, “ceramic solar plate”, “manufacturing and installing method of ceramic solar plate collector”, “method of forming spatial net shaped black porcelain sunlight absorbing layer on ceramic solar plate”, “ceramic solar air channel”, “hot water generator for ceramic solar collecting field” and “wall of ceramic solar plate collectors” etc.

The tailings of vanadium extraction are vanadium containing molten iron melting from vanadium titanium magnetite, and the vanadium containing molten iron is air refined to produce vanadium residue. And the vanadium residue is added with supplementary materials for baking. The baked material is leached using wet method to extract vanadium salt. And the residue after extraction of vanadium salt is the tailings of vanadium extraction.

The tailings of vanadium extraction is abundant in period IV transition metal elements, such as (Fe₂O₃+FeO) 50-70, TiO 5-9, MnO 4-7, Cr₂O₃ 0.002-3, V₂O₅ 0.2-2, SiO₂ 12-26, Al₂O₃ 2-4, CaO 0.9-2, MgO 0.6-2, Na₂O 2-6, K₂O 0.012-0.12. The tailings of vanadium extraction remain pure black in normal temperature and in the process during high temperature baking under different temperatures until molting.

Presently, the yield of the tailings of vanadium extraction are about 300 thousand ton in China, mainly in Sichuan, Hebei, Liaoning Provinces etc. with representative companies of Panzhihua Steel Company, ChengDe Second Chemical Factory and JinZhou Vanadium Company. The tailings of vanadium extraction are complicated compound which is abundant in period IV transition elements, such as Fe, Cr, Mn, V, Ti etc. which may account for 80% of total weight. And the tailings thereof are special industrial castoff, in which the extraction and utilization of any one of the components are inferior to that of the corresponding natural mineral. However, the aggregate thereof is a very stable ceramic black colorant. The tailings of vanadium extraction are not only stable ceramic black colorant, but also themselves excellent black porcelain raw materials. And pure tailings of vanadium extraction can produce vanadium-titanium black porcelain products with excellent physical and chemical properties and with excellent photo-thermal transitional properties. The products thereof have sunlight absorptivity of 0.9 and far-infrared radiance of 0.83˜0.95.

Vanadium-titanium black porcelain was invented in 1984. And it is patented in Apr. 1, 1985. Then in 1986, the technology passed the technical appraisement.

Vanadium-titanium black porcelain can be used for manufacturing hollow solar collector, far-infrared radiation element, artwork, building decorating panel etc. At present, the building decorating panels of Vanadium-titanium black porcelain have a maximal yield, with representative enterprises of Donghong ceramic factory, FoShan, and Acer special ceramic company, Shanghai etc. the production of ceramic building decorative panel (ceramic wall floor tile) in our country listed the first all over the world with a yield of 4 billion square meters occupying about 50% share of the world yield. Because the Vanadium-titanium black porcelain decorative panel uses a large amount of tailings of vanadium extraction, which formerly occupies many yards, and the tailings of vanadium extraction being a heavy burden of vanadium extracting factory now are sold at 160-300 RMB/Ton. And the factories producing the tailings of vanadium extraction all over the country obtain pure income of tens of million of RMB. Blank Vanadium-titanium black porcelain decorative plate has a size of 800×800×12 mm retailed at 25 RMB/m², with factory price of 17 RMB/m², and the annual sales amount to billions of RMB. In 80 s and early 90 s of 20^{th} century, the produced Vanadium-titanium black porcelain hollow solar plates with 300×300 mm amount to tens of thousand of square meters using plaster ejection molding method, and the number of the Vanadium-titanium black porcelain solar water heaters manufactured and used reaches to several hundreds. And the vanadium-titanium black porcelain solar water heaters directly mounted on roofs approximate to a thousand square meters. The object using brick, cement outer frame, magnesite outer frame, water storage tank and specially manufactured ceramic water tank relates to gradual development to vanadium-titanium black porcelain solar roof. The unit plate of the Vanadium-titanium black porcelain solar plate with 300×300 mm has an area of 0.09 square meters, receiving water of 0.9 kg, and the water temperature can reach 100° C. with a single layer of glass plate when sunburned. In 1987, the Vanadium-titanium black porcelain solar water heater was granted with first prize in all of the solar water heaters in Shandong Province. And there is no obvious change of the water before and after being heated by the Vanadium-titanium black porcelain solar water heater. After 10 years usage, the solar plate does not fade, and it is not eroded or aged. However, the method for moulding Vanadium-titanium black porcelain hollow solar plate using plaster mold ejection has a low efficiency and a large consumption of plaster. In addition, the production yield for moulding a large sized solar plate is low. And joints of small-sized plates are too many to be easily installed, and it is hard to develop into an industrial manufacturing method on a large scale and to spread on a large scale.

### SUMMARY OF THE INVENTION

The objects of the invention are as follows:

a large-size hollow ceramic plate with black or fuscous surface or whole body at low cost is made of normal ceramic raw material and ceramic black substance, and an area of an unit plate thereof is larger than 0.5 m² for a solar water heater to provide hot water and for providing cooling, warm wind and hot water on solar roof of a building, and it can also be used for ceramic solar air duct on a large scale and solar thermal collecting field with a large area for generating electricity, for far-infrared drying to save energy, and for constructional heat radiator to save energy, to reduce indoor dust and to enhance health of human.

The object of the invention is implemented as follows:

The normal ceramic raw material according to the present invention mainly means porcelain clay, quartz, feldspar etc., and most ceramic products have a certain requirement of whiteness, thus the raw material with exorbitant Fe content is strictly restricted, the surface or whole body of the large-size hollow ceramic plate has black or fuscous color, without whiteness requirement. And raw material with higher Fe content can be used accordingly, thus the source of the raw material is more extensive with lower cost.

The ceramic black substance according to the present invention means tailings of vanadium extraction, industrial waste residues abundant in period IV transitional metal elements, natural minerals abundant in period IV transitional metal elements, chemicals, chemical products abundant in period IV transitional metal elements and conventional ceramic black colorant abundant in period IV transitional metal elements.

Except for the tailings of vanadium extraction, the industrial waste residue abundant in period IV transitional metal elements means industrial castoff having oxide or compound mainly containing such period IV transitional metal elements as Fe, Mn, Ti, V, Cr, Ni, Cu, Co, Zn, Zr, Nb, Mo, W over 5% or containing a large amount of SiC and simple substance silicon. And the castoffs or called waste residues normally are fuscous and black, including ferroalloy industrial residue, steel industrial residue, nonferrous metallurgical industrial residue, and chemical industrial residue. The ferromanganese slags in ferroalloy industrial residue contains MnO 5-50%, FeO 0.2-2.5%. The silicochromium alloy residue contains Cr₂O₃ 0.1-5%, Cr 2-10.5%, SiC 4-22%, Si 7-8%. Middle, low or mini-carbonchromium scruff contains Cr₂O₃ 2-7%, FeO 1-3%, the ferro-silicon slag contains FeO 3-7%, SiC 20-29%, Si 7-10%. The ferro-tungsten slag contains MnO 20-25%, FeO 3-9%. Ferro-molybdenum slag contains FeO 13-15%. The metal chromium leaching residue contains Cr₂O₃ 2-7%, Fe₂O₃ 8-13%. Metal chromium smelting slag contains Cr₂O₃ 11-14%. Manganese slag contains MnSO₄ about 15%, Fe(OH)₃ about 30%. Silicon-manganese slag contains MnO 8-18%, FeO −0.2-2%. Silicomanganese smoke dust contains MnO₂ 20-24%. Ferro-nickel slag contains FeO 40%, Cr₂O₃ 40%. In the steel industrial residue, converter steel slag contains Fe₂O₃ 1.4-11%, FeO 7-21%, MnO 0.9-4.5%, open hearth furnace slag contains Fe₂O₃ 1.7-7.4%, FeO 7-36%, MnO 0.6-3.9%, rolling steel oxide steel contains approximately 100% of Fe₂O₃. Vanadium-titanium magnetite iron-smelting slag contains TiO₂ 10-17%, Fe₂O₃ about 4%. Vanadium-titanium magnetite steel-smelting slag contains ferric oxide 11-13%, MnO 1-1.2%, V₂O₅ 2.3-2.9%, TiO₂ 2-2.9%. In nonferrous metallurgical industrial residue, furnace copper slag contains FeO 26-34%, copper blast furnace water quenching slag (normally called black sand) contains FeO+Fe₂O₃ 40-50%, copper hydrometallurgy leaching slag contains Fe 50%, Cu 1.13%, Pb 1.05%, Zn0.2%, Bi 0.15%, Mn 0.04%. Pb fuming furnace water quenching slag is the discarded slag of the blast furnace slag produced by Pb-smelting passing through fuming furnace for Pb and Zn recycling, and it contains Fe₂O₃ 38.6-38.7%, Pb 0.06-0.37%, Zn0.8-1.3%. The red mud of the discarded slag drained from aluminum plant when manufacturing Al₂O₃ contains Fe₂O₃ 8-10%, TiO₂ 2.5%. In chemical industrial residue, the pyrite cinder produced when sulfuric acid is manufactured based on pyrite contains Fe₂O₃ 41-49%, FeO 10-10.4%, TiO 0.4-0.5%, MnO 0.1-0.5%, CuO 2-4%.

The natural minerals means minerals abundant in period IV transitional metal elements, such as normal iron ore with maroon color containing Fe₂O₃ 30-70%, chromite with wine color containing Cr₂O₃ 30-54%, FeO 12-17%, ilmenite with black purple color containing TiO 50-60%, FeO 22-35%, Fe₂O₃ 7-15%, MnO 0.5-4%, manganese ore with dark brown color containing MnO₂ 40-78%, Mn₃O₄ 4-32%, Fe 1-18%, nickel containing limonite with brown color containing Ni 1.2-1.4%, Co 0.1-0.2%, Cr₂O₃ 3%, Fe 35-50%, vanadium-titanium magnetite with black color containing V 0.4-1.8%, TiO₂ 9-34%, Fe₂O₃ 15-50%, FeO 9-34%, MnO 0.2-6%, Cr₂O₃ 0.1-0.7%, niobite with black color containing Nb₂O₃ 9-68%, Ta₂O₅ 1-15%, TiO 1-3%, MnO 1-3%, SnO 2-5%, FeO 12-20%, wolframite with black brown color containing WO₃ 65-67%, FeO 12-15%, MnO 8-12%, Sn 0.17-0.8%. The objects for using the industrial castoffs and natural minerals relate to provide coloring components for the whole body or surface layer of the ceramic solar plate, so that the whole body or surface layer would present fuscous or black color to absorb more sunlight or emit more far-infrared rays.

The compounds and chemical products abundant in period IV transitional metal elements means those containing period IV transitional metal elements Ti, V, Cr, Mn, Fe, Co, Ni, Cu. And these compounds can be used as ceramic black colorant.

The conventional ceramic black colorant abundant in period IV transitional metal elements means the mixtures of above compound and chemical products through purposefully compounding and processing for presenting ceramic with black color.

The large-sized hollow ceramic plate according to the invention is classified by shape, material and use. When it is classified by shape, the large-sized hollow ceramic plate can be classified into porous ceramic plate, semi-through hole ceramic plate, through-hole ceramic plate, and sealing ceramic plate. When it is classified by material, the large-sized hollow ceramic plate can be classified into compound ceramic plate and homogeneous ceramic plate. The compound ceramic plate means the large-sized hollow ceramic plate that is integrally formed by a black ceramic surface layer with a ceramic matrix made of normal ceramic raw material through high temperature sintering. The homogeneous ceramic plate means the large-sized hollow ceramic plate that has a black or fuscous whole body. When it is classified by use, the large-sized hollow ceramic plate can be classified into a large-sized hollow ceramic solar plate, a large-sized hollow ceramic far-infrared radiation plate and a large-sized hollow ceramic radiation plate for building.

A method for manufacturing a large-sized hollow ceramic plate is provided. The ceramic plate is manufactured in the following steps:

processing normal ceramic raw material into pug through conventional method for processing ceramic raw material,

molding the pug by extruding method of vacuum extruder with a microcellular mold to form porous, semi through hole, through hole, sealing hollow ceramic plate bisque;

milling tailings of vanadium extraction and/or other industrial waste residue abundant in period IV transitional metal elements and/or natural mineral abundant in period IV transitional metal elements and/or compound abundant in period IV transitional metal elements and/or ceramic black colorant into slurry while adding or not adding normal ceramic raw material, covering the slurry on the surface of the hollow ceramic plate bisque to dry and burn into black-porcelain compound ceramic plate, spatially reticular black-porcelain compound ceramic plate; or processing other industrial waste residue abundant in period IV transitional metal elements other than tailings of vanadium extraction and/or natural mineral abundant in period IV transitional metal elements and/or compound abundant in period IV transitional metal elements and/or ceramic black colorant into pug by conventional ceramic raw material processing method, moulding the pug by extruding method of vacuum extruder with a microcellular mold and forming porous, semi through hole, through hole, sealing homogenous ceramic plate through processing, drying and burning, the large-sized hollow ceramic plate is the above black-porcelain compound ceramic plate, spatially reticular black-porcelain compound ceramic plate, homogenous ceramic plate and the above porous, semi through hole, through hole, sealing ceramic plate. The compound ceramic plate, the spatial reticular black porcelain compound ceramic plate, the ceramic end-head plate having entry and exit ports and the through hole ceramic plate are glued to form glued type sealed ceramic plate. And entry and exit ports of a plurality of sealed ceramic plates are connected in series, or a plurality of porous ceramic plate, semi through hole ceramic plate, through hole ceramic plate and a large sized hollow ceramic plate attachment are glued together or hitched in series to form a longitudinal array of large-sized hollow ceramic plates. And insulating and thermal preserving material is bonded to the bottom and periphery of the large-sized hollow ceramic plate or the longitudinal array of large-sized hollow ceramic plates, a transparent cover plate is covered above to form a ceramic solar plate collector and a longitudinal array of ceramic solar plate collectors. The large-sized hollow ceramic solar plate collector and the longitudinal array of large-sized ceramic solar plate collectors can be used to a ceramic solar hot water heater, ceramic solar roof, ceramic solar wind duct electric generation device, hot water electric generation device of ceramic solar collecting field. The large sized hollow ceramic plate can be used as ceramic far-infrared radiation plate and ceramic building central heating radiation plate.

A method for manufacturing a large-sized hollow compound ceramic plate is provided as follows:

processing normal ceramic raw material into pug through conventional method for processing ceramic raw material,

molding the pug by extruding method of vacuum extruder with a microcellular mold to form porous ceramic plate bisque, through processing, through holes communicating with each other at both ends or at an end to form through hole ceramic plate bisque with the through holes being communicated with each other at both ends and to form semi-through hole ceramic plate bisque with the through holes being communicated with each other at one end,

adhering end head plate bisques with entries and exits having the same material at both ends of the through hole ceramic plate bisque to form a sealing ceramic plate bisque,

milling tailings of vanadium extraction and/or other industrial waste residue abundant in period IV transitional metal elements and/or natural mineral and/or compound and/or ceramic black colorant into black slurry while adding or not adding normal ceramic raw material, covering the black slurry on surfaces of the porous ceramic plate bisque, through hole ceramic plate bisque, semi-through hole ceramic plate bisque and sealing ceramic plate bisque to dry and burn into a large-sized porous, through-hole, semi-through hole, sealing black-porcelain compound ceramic plate with matrix being normal ceramic and a surface being a black-porcelain layer, which is generally termed as large-sized hollow compound ceramic plate.

The surface black ceramic layer of the large-sized hollow compound ceramic plate is formed into spatial reticular structure to increase solar absorptivity, which is generally termed as a large-sized hollow spatial reticular black-porcelain compound ceramic plate, the manufacturing method is as follows:

drying the hollow ceramic plate bisque into a sufficient dried bisque by conventional drying method,

milling the tailings of vanadium extraction and/or other industrial waste residue abundant in period IV transitional metal elements and/or natural mineral abundant in period IV transitional metal elements and/or compound abundant in period IV transitional metal elements and/or ceramic black colorant and/or conventional ceramic black colorant into slurry by adding or not adding normal ceramic raw material,

spraying the slurry on the surface of the dried hollow ceramic plate bisque by compressing air with a single spraying gun or a plurality of spraying guns,

controlling pressure of the compressing air, flow rate and ratio of the slurry so that droplets that initially contact the surface of the dried ceramic plate bisque are formed into mud particles adhered to the surface of the bisque which has a certain strength and is relatively dry due to the rapid water absorption of the dried bisque and the surface tension of the droplets, the following ejected droplets firstly meeting the mud particles with certain absorptivity which are projected from the surface, and then adhering on the mud particles to form non-uniform, noncontinuous, absorbed droplet mud particle accumulating bodies with a certain strength in turn, the accumulating bodies being accumulated into post shape, sharp towered shape, vertical wall shape, honeycomb shape and porous shape,

stopping ejecting droplets when these spatial accumulating bodies reach to a certain height and lose absorbing capability so that spatial reticular black ceramic bisque layer is formed on the surface of the surface of the hollow ceramic bisque plate,

burning the hollow ceramic bisque plate having the spatial reticular black ceramic bisque layer with high temperature after drying,

controlling the burning temperature and the time period thereof so that the spatial reticular black ceramic bisque layer and the hollow ceramic plate bisque are sintered into a spatial reticular black ceramic layer and porcelain type hollow ceramic plate matrix at the same time, the spatial reticular black ceramic layer and the porcelain type hollow ceramic plate matrix being compounded into an integral body by high temperature sintering to form spatial reticular black porcelain compound ceramic plate,

when spraying, the spraying gun moves relatively with respect to the hollow ceramic plate bisque surface with a certain angle, when spraying with a single spraying gun, the single spraying gun moves and scans regularly above the surface of the bisque plate so that the moving speed and slurry ejecting speed correspond with bisque water absorbing speed thereof, and the droplet accumulating bodies are ensured with a certain water absorbing capability, so that the a lot of the water content of the droplets adhered on the accumulating bodies is transferred into the dried bisque by the relatively dried accumulating body, and the newly adhered droplets lose part of the water rapidly to have a certain shape and strength, preventing the droplets from converging into flowing slurry which may lead to the accumulations to be collapsed into planar layer, when spraying with a plurality of spraying guns, the hollow ceramic plate bisque moves under the spraying guns so that the moving speed, spraying gun intervals and the slurry ejecting speed correspond with the bisque water absorbing capability to achieve the above objective,

the slurry prescription and the water content are adjusted to determine the cohesion among particles in the slurry,

the pressure of the compressing air, flow rate and slurry ratio are controlled for determining the speed and size of the droplets, the droplets are the hollow slurry ball of the mixture of slurry and the air, when adhered to the accumulations, part of the water contents thereof are lost to be hardened into hollow hard shells with part of the ball body being broken forming spatial reticular porous accumulating body, the prescription of the slurry, the cohesion and the water losing speed determine the average diameters and the heights of the accumulating bodies, the heights of the accumulating bodies are 0.1˜3 mm, the capillary pores in the accumulating bodies are the water moving passages formed when the dried bisque absorbs water content, when sintered, they are formed into micro-cavity, each post, sharp tower, vertical wall and honeycomb wall of the accumulating body after sintering are filled with cavities with cavity diameters of 0.1˜50 micron, and the spatial reticular black ceramic layer presents black color.

A manufacturing method of a large-sized hollow homogenous ceramic plate is provided, comprising the following steps:

processing other industrial waste residue abundant in period IV transitional metal elements other than tailings of vanadium extraction and/or natural mineral abundant in period IV transitional metal elements and/or compound abundant in period IV transitional metal elements and/or ceramic black colorant into pug by conventional ceramic raw material processing method,

extruding the pug into porous ceramic plate bisque by extruding method with a vacuum extruder using a porous mold, the through holes are communicated with each other at both ends or at an end through processing to form a through hole plate bisque with through holes at both ends connected together or a semi through hole plate bisque with through holes at an end connected together, and a sealed ceramic plate bisque is formed by adhering end-head plate bisques having entry and exit ports, which have the same material, at both ends of the through hole plate bisques using ceramic slurry, after drying and burning, various large-sized hollow homogenous ceramic plate, of which the whole body has black or fuscous color, is obtained.

The above large-sized sealed ceramic plate can be molded by gluing method: the above end-head plate bisque having entry and exit ports is burned into ceramic end-head plate having entry and exit ports, and the glued type sealed ceramic plate is formed by adhering it to both ends of the through hole plate using organic or inorganic adhesive.

ceramic end head plate, ceramic entry and exit pipe ports, ceramic end-head plate with the ceramic entry and exit pipe ports, ceramic end head plate with large pipe port, ceramic hitching end-head plate with large pipe port, porous ceramic hitching joint, single-hole ceramic hitching joint, totally called large sized hollow ceramic plate attachments, are produced by conventional ceramic manufacturing method using normal ceramic raw material, the surfaces thereof are compounded with black ceramic layers, or the large sized hollow ceramic plate attachments are produced by organic material, elastic organic material or metal material, the longitudinal array of the large-sized hollow ceramic plates are formed by attaching a plurality of porous ceramic plates, semi-through hole ceramic plates, through hole ceramic plates with the large-sized hollow ceramic plate attachment by adhering or hitching using organic or inorganic material, the inner portions of the longitudinal arrays are communicated with each other forming a passage, thus forming an adhered longitudinal array of large-sized hollow ceramic plates, when used under sunlight, the bottom and peripheral surfaces thereof are surrounded by heat preserving material, at this time, a transparent covering plate should be covered in time without passing water, so that when under insolation in sunlight, the adhesive cures automatically.

The adhesive used can be various organic and inorganic ones, such as epoxy adhesive, phenolic adhesive, silicone adhesive, nitrogenous heterocyclic adhesive, silicate adhesive or phosphate adhesive etc. The organic adhesives of epoxy adhesive, phenolic adhesive, silicone adhesive, nitrogenous heterocyclic adhesive can endure high temperature to 200˜400° C. in long time. The inorganic adhesives of silicate adhesive and phosphate adhesive can endure high temperature to 900˜1700° C. in long time. Both types can endure low temperature as to several tens of Celsius under zero. Ceramic solar plate and far-infrared radiation plate for building central heating can use organic adhesives under extreme circumstances from −30° C. (winter night) to 200° C. (insolating of solar plate). And the far-infrared radiation plate is used under 400˜600° C., mainly using inorganic adhesives.

Large sized hollow ceramic plate and the longitudinal array of large sized hollow ceramic plates can be used for solar energy, far-infrared radiation drying, building central warming radiation. When used for solar energy, they are called as ceramic solar plate and longitudinal array of ceramic solar plate. When used for far-infrared radiation, they are called as ceramic far-infrared plate and longitudinal array of ceramic solar plate. When used for building central warming, they are called ceramic radiation plate and longitudinal array of ceramic radiation plates. The ceramic solar plate and the longitudinal array of ceramic solar plates are combined with the heat preserving and insulating material, the transparent cover plate to form a ceramic solar plate collector and longitudinal array of ceramic solar plate collectors which can be used for ceramic solar water heater, ceramic solar roof, ceramic solar wind duct electric generation device and hot water electric generation device of ceramic solar collecting field.

The manufacturing method of a ceramic solar plate collector is as follows:

Heat preserving and thermal insulating material with a certain strength and thickness is bonded to the bottom and four peripheral sides of the ceramic solar plate by a combination of casting, mold pressing, spraying, adhering and mechanical connecting, the heat preserving and thermal insulating material at the side surfaces is higher than the solar collecting surface of the ceramic solar plate, operation spaces for the connecting pipes and fixing members during connection is preserved between the two plates in the heat preserving and insulating material at the interfaces of the both ends of the ceramic solar plate, forming ceramic solar plate collecting box, and transparent covering plate is covered on the top of the ceramic solar plate collecting box to form the ceramic solar plate collector, the heat preserving and insulating material on the ceramic solar plate collector is of a single type or of a compound of a plurality of types, similarly, the heat preserving and insulating material can be bonded to the bottom and four peripheral surfaces of the longitudinal array of the ceramic solar plate collectors, and the heat preserving material on the side surface is higher than the solar collecting surface of the ceramic solar plate, the longitudinal array of the ceramic solar plate collectors is formed after a transparent covering plate is covered on the top thereof.

The heat preserving and insulating material is organic micro-porous one, such as foamed plastics, for example, hard polyurethane, phenolic, urea formaldehyde, polyolefin, polyvinyl chloride, polystyrenes etc., or inorganic micro-porous one, for example, micro-porous calcium silicate, micro-porous calcium aluminate, diatomite, inorganic cementitious material etc., or mixture of fibrous heat preserving and insulating material, such as rock wool, mineral wool, glass wool, fibrous cotton of aluminum silicate, inorganic manmade fiber, organic fiber, with binder, or a mixture of powdered granular heat preserving and insulating material, such as expanded perlite, expanded vermiculite, haydite, litaflex etc, with binder, or laminated insulating material, such as laminated hollow structured insulating material, laminated sandwich structured insulating material etc. In use, the surface of the heat preserving and insulating material that all sunlight can shine thereupon is covered with aging resistant coating layer, such as polyurea, epoxy resin, acrylic resin etc.

The ceramic solar collecting box or ceramic solar plate collector can be manufactured in factory, which can be made industrialized and the installation can be modularized. The heat preserving and insulating material bonded to the bottom and periphery of the ceramic solar plate is also the packaging material for ceramic solar plate when leaving factory, which makes the transportation, assembly/disassembly, installation safer, and the later installation and maintenance more rapid, simpler and more convenient.

The structure of the ceramic solar water heater is as follows:

Normal solar water heater comprises thermal collectors, brackets and water tanks. And when normal solar collector is exchanged to ceramic solar plate collector or the longitudinal array of ceramic solar plate collectors, then a ceramic solar water heater is formed.

The structure and installing method of the ceramic solar roof are as follows:

The longitudinal array of the ceramic solar plate collectors or the longitudinal array formed by ceramic solar plate collectors with interface to interface by connecting pipe are arranged in order on a roof structure layer covered with a waterproof layer, and upper and lower influx pipes and water tank are arranged accordingly, the gaps between transparent covering plates are coated with waterproof material, and plates with Q shape are arranged in intervals forming ceramic solar roof, the heat preserving layer at the bottom of the ceramic solar plate collector is also the heat preserving layer of the roof, both share the heat preserving layer. The transparent covering plate is the pervious, heat preserving and waterproof layer as well as the upper waterproof layer of the roof. The hot water generated by the summer solar roof drives the absorption type air conditioner to cool the building. In winter, the water in the ceramic solar roof is released, and the air in the ceramic solar plate collector is heated by sunlight, thus pumping the hot air into room or providing central heating to room in the building by passing through the spiral pipe in the water tank, the ceramic solar roof can provide hot water in spring, summer, autumn and winter, and a ceramic solar wall is formed by installing the ceramic solar roof on the wall.

The transparent cover plate refers to the glass plate, transparent plastic plate etc.

The connecting pipe refers to aging resistant and corrosion resistant soft plastic pipe, silicone pipe and rubber plastic pipe etc., hard copper pipe, stainless steel pipe, ceramic pipe, plastic pipe etc., the fixing and sealing of the soft pipe can use stainless steel hoop, copper clamp, clip spring, hot shrink belt etc., the fixing and sealing of the hard pipe can used organic, inorganic adhesive, cementitious material etc.

The Ω shaped plate refers to the one manufactured by galvanized steel plate or colour coated steel sheet, the width of the bottom edge is 60-200 mm, the edge height thereof is 80˜250 mm, the edge width is 1˜30 mm, the two wings at the bottom edge are fixed to the roof or on the slope, which can provide protection and shield to the ceramic solar plate collector. When installing and maintaining, it can be used as supporting point for operators.

The ceramic solar wind duct power generation device is as follows:

The longitudinal arrays of the ceramic solar plate collectors are installed on hillside facing south and sloping fields at foot of the hillside, to be grouped along the upper-to-lower direction and left-to-right direction, each group having a plurality of the longitudinal arrays, the solar plates in the longitudinal arrays of the ceramic solar plate collectors are communicated with end to end in the upper-to-lower direction, the lower port is communicated with a wind inlet pipe, the upper port is communicated with hot wind branch duct, the wind inlet pipe and the hot wind branch duct inclined to a certain angle with horizontal plane, the air flow directs from lower to upper direction, the lower port of the wind inlet pipe is open, the upper port is sealed, the lower port of the hot wind branch duct is sealed, the upper port is communicated with the main wind duct, the air enters from the lower port of the wind inlet pipe, and is heated by sunlight in the collectors, then enters upwardly into the main wind duct through hot wind branch duct and drained from the upper port of the main wind duct, and there is negative pressure at the inlet of the wind inlet pipe, and there is positive pressure at the outlet of the main wind duct, an air turbine is arranged at the inlet of the wind inlet pipe and the outlet of the main wind duct, the air forms into air flow under the pressure difference pushing the turbine to drive generator into generating electricity, or the wind inlet is removed, and air turbines are installed stage by stage in the hot wind branch duct and the main wind duct.

Normally, the inner and outer temperature difference is 30° C., and the temperature difference inside and outside of the longitudinal array of the ceramic solar plate collectors may go beyond 120° C. The ceramic solar wind duct may have a higher efficiency than the solar chimney. And the cost of the longitudinal array of the ceramic solar plate collectors is lower than that of the glass house, the hot wind branch ducts and the main wind duct are constructed along the hill, which has a lower cost than that of the chimney. Therefore, the ceramic solar wind duct may have a lower power generation cost.

A hot water electric power generation device in a ceramic solar collecting field is provided as follows:

The hot water electric power generation device in a ceramic solar collecting field is constructed on a hillside facing south or a relatively flat desolate beach, waste land, desert, the south facing hillside has inclination with the horizontal plane approximately to local latitude, about 5˜55°, and the relatively flat surface is finished into a sloping surface facing south with serrated cross section along a direction from north to south, and ditches are dug with large-scale ditcher in a east-to-west direction forming the sloping surface of the ditch, the excavated soils, stones and sands are accumulated on a floor surface at a side of the sloping surface facing south of the ditch, forming an accumulation sloping surface, the sloping surface of the ditch and the sloping surface of the accumulation both constitute a sloping surface facing south of the ceramic solar collecting field, when a neighboring ditch is excavated, the sloping surface facing north of the ditch leaves a certain distance from the accumulation of a previous ditch, leaving a horizontal passage therebetween, the slop top, slope face and ditch bottom are leveled, tamped and strengthened, upflow pipe, i.e. water outlet pipe, is laid on the slope top, and a horizontal downflow pipe, i.e., the water inlet pipe is laid at a distance of about 100˜500 mm from the ditch bottom, and the longitudinal array of the ceramic solar plate collectors is provided between the upflow pipe and the downflow pipe, an upper port of the longitudinal array is connected with the upflow pipe, the lower port thereof is connected with the lower water pipe, and the water in the ceramic solar plate is heated by sunlight, hot water enters into hot water tank along the water outlet pipe, the hot water in the hot water tank enters into the power generation device, converting thermal energy into kinetic energy and doing work accordingly, then the water enters into cool water tank, or the hot water in the hot water tank enters into convergent type high temperature solar device to be further heated into a mixture of hot water and steam with higher temperature, the steam with high temperature and high pressure enters into the power generation device for generating electricity, and then enters into the cool water tank, the water with lower temperature in the cool water tank enters into the longitudinal array of the ceramic solar plate collectors for being heated by solar energy again.

Compared with geothermal water power generation, the hot water obtained by ceramic solar collecting field has a flow rate larger than that of the hot water supplied by any one of known geothermal field. And there is no great risk of exploring geothermal resources and no huge drill with large investment and waste water recharging are needed, and the obtained hot water does not foul or erode the devices. Thus, the power generation cost of the ceramic solar collecting field may lower than that of geothermal water power generation.

Ceramic far-infrared radiation plate is provided as follows: the conventional electrical heating bodies are penetrated through the through holes of the large-sized porous ceramic plate, and inorganic thermal insulation materials, such as alumina silicate fiber felt, rock wool felt, mineral wool felt, glass fiber felt etc., which is high temperature resistant are covered at side surfaces and a back surface thereof, forming the ceramic far-infrared radiation plate, air flow with high temperature, such as fuel gas with high temperature, is passed in the longitudinal array of the large-sized hollow ceramic plates with large pipe ports, and heat preserving and insulating material is covered at both sides and the back surface thereof, forming a longitudinal array of large-sized hollow ceramic far-infrared radiation plates and covering the above thermal insulation materials at both side surfaces and the back surface thereof, black-ceramic surfaces of the ceramic far-infrared radiation plate and the longitudinal array of the large sized hollow ceramic far-infrared radiation plates are far-infrared radiation surfaces for intermittent type far-infrared drying furnace and continuous type far-infrared drying tunnel. Compared with far-infrared element, it has a lower cost, a longer lifetime, and a higher average efficiency during the lifetime.

A ceramic central heating radiation plate for building is provided as follows:

Entry and exit ports of a large-sized sealing ceramic plate or the longitudinal array of large-sized hollow ceramic plates are modified to be conformed with interfaces of a central heating system for a building, when hot water or steam is circulated therein, ceramic central heating radiation plate for building is thus formed. The heat radiation plate irradiates a large amount of energy outwardly in far-infrared rays, thus reducing air convection, i.e., reducing the diffusion the dust and bacteria in the indoor convection circulation. The far-infrared rays are advantageous to increase blood circulation of human body, which is good for human health. And the heat radiation plate has low cost and long lifetime.

The cost, lifetime and efficiency of the large-sized hollow ceramic plate are as follows:

Presently, a ton of normal ceramic solid rough blank is approximately 600 RMB, the cast iron 3000 RMB, the steel material 4500 RMB, the aluminum material 24000 RMB, the copper material 70000 RMB. The price of the ceramic material is low because the raw material reserves are large, the distribution is wide, the transporting distance is short, and the manufacturing temperature can be lowered to 1200° C. with simple process. The prices of metal materials are expensive because the raw material reserves are low, the effective content is low, and the transporting distance is far, and the manufacturing temperature is about 160° C., or need electrolysis for production with complex manufacturing process, and these factors are hard to be changed. Presently, the vanadium titanium black-porcelain decorative rough blank with a size of 800×800×12 mm can be lower than 17 RMB/m², the total thickness of the large-sized hollow ceramic plate is 20˜40 mm, the wall thickness is 1˜5 mm. From the type of the raw material, raw material dosage per unit area, the shaping method and efficiency, the energy consumption for drying and burning, the device classes, the factory area of the same yield, the total number of workers being used, it can be deemed that the producing costs of both are comparable when both are produced in large scale.

The physical and chemical properties of ceramic material are stable, erosion-resistant, aging resistant, non-toxic, harmless and non-radioactive. If the selected products to be manufactured will not bear violent mechanical and thermal shock or rules are regulated to avoid the violent mechanical and thermal shocks of the products, the using lifetime can be extended to hundreds of years or longer.

The wall thickness of the large-sized hollow ceramic plate can reach 1˜5 mm. And the uses of solar plate, infrared radiation plate, belching plate are related to heat conduction. Although the ceramic material is non-conductive to heat, the wall thereof is thin, the heat convection distance is short. Therefore, the large-sized hollow ceramic plate still has high efficiency. Because the surface layer of the black-porcelain has a stable light heat property, it can have high average efficiency during long lifetime.

Facing the scattering, thin and low energy-density whereas huge amount solar energy, only efforts are put into striving for technology breakthrough, can the very cheap material, structure and application manner with long lifetime and high efficiency be used for economic, efficient and wide usage of solar energy, so that the solar energy can substitute as an substitutable energy. The development and large application of the large-sized hollow ceramic plate are one of the effective ways to be used as a large-scale substitutable energy.

Additional aspects and advantages of the embodiments of present invention will be given in part in the following descriptions, become apparent in part from the following descriptions, or be learned from the practice of the embodiments of present invention.

### BRIEF DESCRIPTION OF THE DRAWINGS

These and other aspects and advantages of the invention will become apparent and more readily appreciated from the following descriptions taken in conjunction with the drawings in which:

FIG. 1 shows a porous ceramic plate bisque 1 moulded by vacuum extrusion moulding method using normal ceramic pug or ceramic pug added with period IV transitional metal elements, a through-hole ceramic plate bisque 2 which is manufactured with the through hole at both ends communicating with each other, an end head plate bisque 3 with both ends adhering entry and exit ports, and a sealed ceramic plate bisque 4, 1, 2, 4 designates the porous ceramic plate, the through hole ceramic plate and the sealed ceramic plate after sintering.

FIG. 2 shows that a spraying gun sprays misted slurry with a certain angle relative to a surface of the sealed ceramic plate bisque.

FIG. 3 shows that a single spraying gun moves over the surface of the bisque plate for scanning movement by spraying misted slurry line by line and forming spatial reticular bisque layer of the black porcelain sunlight absorbing layer;

FIG. 4 shows the spatial reticular black porcelain sunlight absorbing layer sintered to be compounded on the surface of the sealed ceramic plate;

FIG. 5 shows a ceramic solar plate thermal collecting box, i.e., the material, shape and structure of the ceramic solar plate collector which is not installed with a transparent plate;

FIG. 6 shows a method of connecting the ceramic solar plate collector with soft hose and pipe holder;

FIG. 7 shows a longitudinal array of large-sized hollow ceramic plates cemented by a large port ceramic end head plate, a large port ceramic hitching end head plate, a through hole ceramic plate, a porous ceramic plate, a porous ceramic hitching joint and a single-hole ceramic hitching joint;

FIG. 8 shows a longitudinal array of large-sized hollow ceramic plates hitched by a large port elastic hitching end head plate, semi through hole ceramic plate and an elastic belt ring;

FIG. 9 shows a ceramic solar roof composed of a longitudinal array of large-sized hollow ceramic plate collectors, 29 designates backing plate supported by operators during installation and maintenance, the backing plate being supported by a plate with Q cross section.

FIG. 10 is a side view of the ceramic solar roof, showing positional relationship between the transparent covering plate, the ceramic solar plate and the lower waterproof layer, the transparent covering plate is a part of the longitudinal array of the ceramic solar plate collector, which also functions for a waterproof layer on a house roof;

FIG. 11 shows the shape and size of the plate with Ω cross section, a width of the bottom side N is 60˜200 mm, and an edge height M is 80˜250 mm, and an edge width L thereof is 1˜30 mm.

FIG. 12 shows a partial structure of a ceramic solar wind duct generation device.

FIG. 13 shows an integral structure of the ceramic solar wind duct generation device and a constructing method thereof.

FIG. 14 shows structure and layout of a ceramic solar collecting field hot water electric generation device;

FIG. 15 shows the structures and connecting ways of a slope facing south of the ceramic solar collecting field and a longitudinal array of ceramic solar plate collectors;

FIG. 16 shows a constructing method of a serrated slope facing south of the ceramic solar collecting field.

In the figures:
1—a porous ceramic plate bisque, a porous ceramic plate
2—a through hole ceramic plate bisque, a through hole ceramic plate
3—a ceramic end head plate bisque with entry and exit ports, a ceramic end head plate with entry and exit ports
4—a sealed ceramic plate bisque, a sealed ceramic plate
5—a bisque layer of a spatial reticular black-porcelain sunlight absorbing layer;
6—a spraying gun
7—misted black-porcelain slurry
8—a burnt spatial reticular black-porcelain sunlight absorbing layer and micro-cavities thereof
9—a transitional bonding layer formed between the spatial reticular black-porcelain layer and the sealed ceramic plate when burning
10—a sealed ceramic plate of a compound spatial reticular black-porcelain layer
11—a sealed ceramic solar plate combined with heat preserving and insulating material
12—heat preserving and insulating material
13—stainless steel pipe holder
14—a soft connecting pipe which is aging resistant
15—a large pipe port ceramic end head plate
16—a porous ceramic hitching joint
17—a single hole ceramic hitching joint
18—a large pipe port ceramic hitching end-head plate
19—adhesive
20—an elastic hitching end-head plate with a large pipe port
21—a semi through hole ceramic plate
22—an elastic belt ring
23—a longitudinal array of the large-sized hollow ceramic solar plate collectors
24—a Ω shape plate
25—fluid upper collecting pipe
26—fluid lower collecting pipe
27—a lower waterproof layer
28—a glass plate or other transparent cover plate which also functions as a waterproof layer on a roof
29—a backing plate for installation and maintenance
30—main wind duct
31—hot wind branch passage
32—wind influx pipe
33—main wind duct turbine
34—wind influx pipe turbine
35—peak
36—a slope facing south
37—water outlet pipe (hot water pipe)
38—water inlet pipe (cold water pipe)
39—hot water pot
40—cold water pot
41—turbo-generator set
42—an accumulating part of a slope facing south
43—a horizontal passage
44—a channel
45—ground surface

### DETAILED DESCRIPTION OF EMBODIMENTS OF THE INVENTION

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

### Embodiments

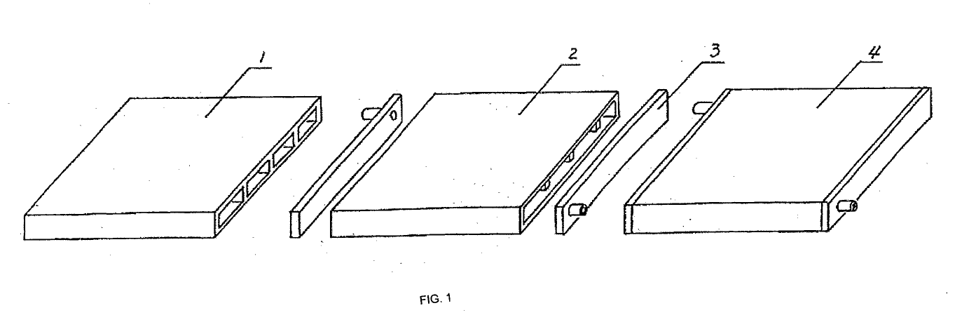

1. As shown in FIG. 1, slurry is milled by normal ceramic raw material such as clay, quartz, feldspar by adding water. After sieving and pressurizing, it is formed into pug with water content of 18%. And it is formed into mud discharge after crude mud refining and vacuum mud refining. Then it is extruded into porous plate bisque 1 with a width 700 mm, total thickness 30 mm, wall thickness of 3 mm, length of 1150 mm, having 21 holes. And the partial interwall between both ends of the porous plate is removed to be formed into a through hole plate bisque 2 with the through holes at both ends communicating with each other. And when it is adhered with an end-head plate 3 having entry and exit pipe ports with the same material at both ends by the slurry, it is formed into a sealed platebisque 4. After drying, it is prepared for later use. Slurry is milled by vanadium titanium magnetite of 35%, manganese ore of 30%, chromite of 25% (weight percentage, the same below) and normal ceramic raw material of 20% filtering through 200-mesh. Then it is coated on surface of the sealed part plate bisque with conventional method. After drying, it is burned to 1200° C. to form into a large-sized hollow compound ceramic solar plate with a surface of a black ceramic sunlight absorbing layer and a matrix of normal ceramic.

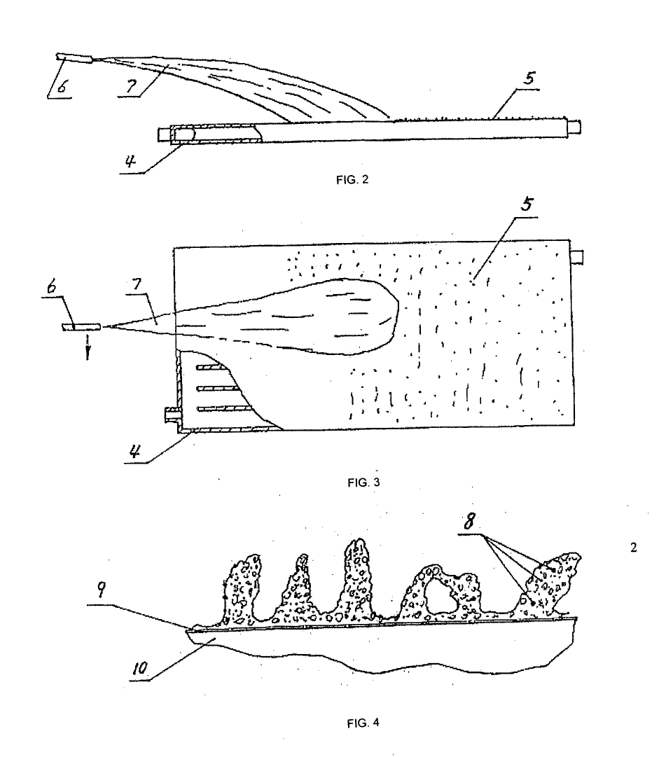

2. As shown in FIGS. 2-4, the tailings of vanadium extraction of 65%, Suzhou clay of 20%, flintclay of 15% are ball-milled for 24 hours by adding water. The slurry 7 has a water content of 40%. And the slurry 7 is sprayed onto the dried surface of the hollow ceramic solar plate bisque with 1200 mm×800 mm by compressing air, the air pressure is 0.6 MPa, the spraying gun 6 sprays downwardly with 70° with respect to vertical plane, the spraying gun has a distance of 300 mm with the bisque surface, and the gun sprays for 2 minutes line by line so that the droplets sprayed at the initial stage are moisture absorbed and cured by the surface of the plate, the later sprayed droplets on the accumulations are moisture absorbed and cured by the cured accumulations, forming into a spatial reticular black-porcelain sunlight absorbing bisque layer 5 finally. The whole solar plate bisque is dried and burnt under 1240° C., the height of the accumulation is 0.2 mm, forming into vanadium-titanium black-porcelain compound ceramic solar collecting plate having a spatial reticular black-porcelain sunlight absorbing layer 8.

3. Pug is formed by ceramic raw material of 40% with ferric oxide of 5%, titanium oxide of 3.2%, ferromanganese slag of 25%, metal chromium smelting slag of 20% and pyrite cinder of 15%, which are deemed normally as inferior raw material, using normal ceramic devices and processes. After vacuum mud refined and decayed, it is extruded into a porous ceramic plate bisque body with a vacuum extruder The bisque plate is dried and burnt to be forming a homogenous ceramic solar plate which has an integral black grey color.

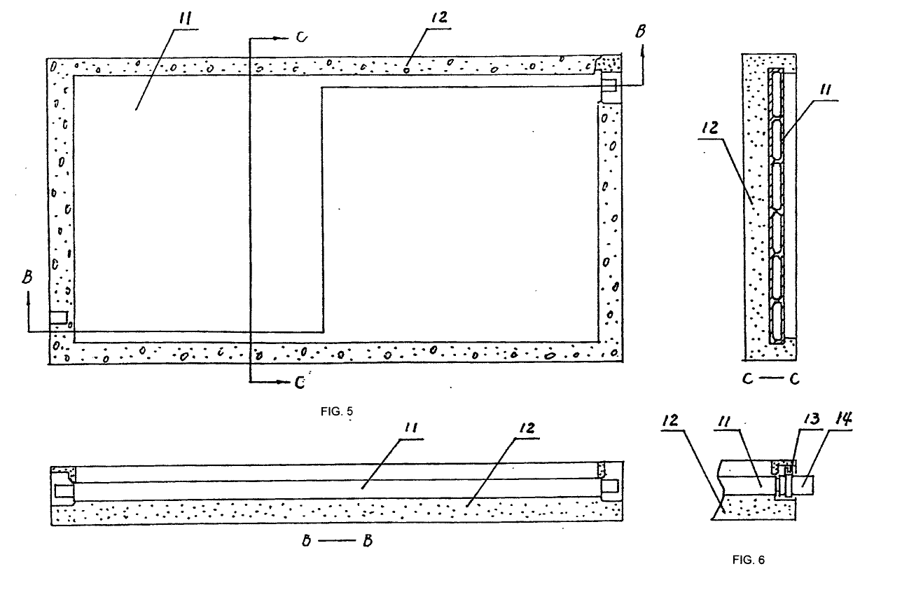

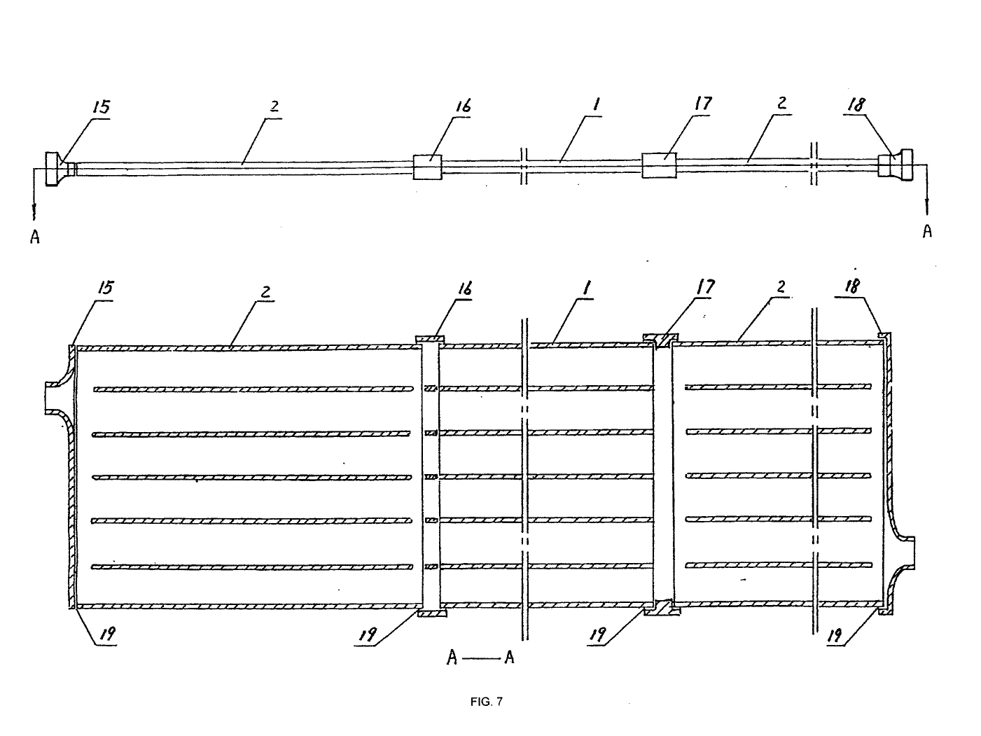

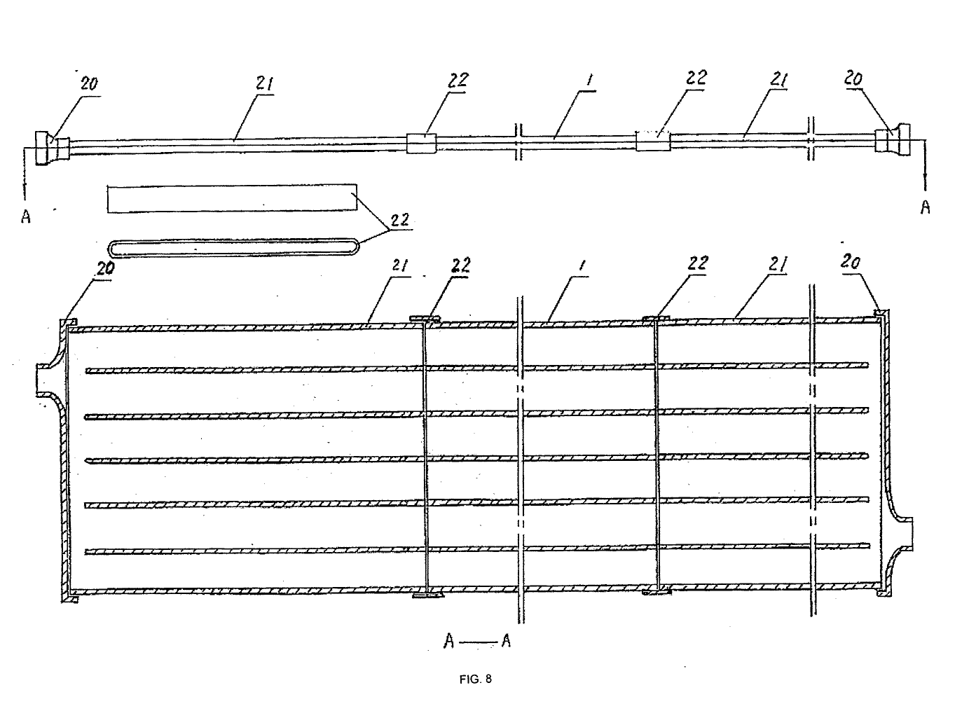

4. As shown in FIGS. 5 and 6, the liquid raw material of hard polyurethane foam plastic is well-mixed to be injected into a mold. After foaming, it is cured so that the polyurethane foam plastic 12 bonds on the bottom and peripheral surfaces of the compound ceramic solar plate, the peripheral foam plastic 12 is higher by 25 mm than that of the surface of the heat absorbing surface of the solar plate. And the mold is opened for taking out the integral body of the polyurethane foam plastic and the compound ceramic solar plate. The outer surface of the polyurethane foam plastic has a smooth, hard un-foamed layer. The integral body is the compound ceramic solar plate heat collecting box, the upper transparent cover plate is the compound ceramic solar plate collector.

5. The compound ceramic through hole plate with a spatial reticular black-porcelain sunlight absorbing layer having a length of 1400 mm and a width of 800 mm is adhered with the ceramic end-head plate with entry and exit pipe ports by epoxy resin to form a sealed ceramic solar plate, the bottom and the periphery are bonded with hard polyurethane foam plastic, the surface thereof is bonded with a glass plate with 4 mm thickness to form a large-sized sealed ceramic solar plate collector, which is inclinedly provided on a bracket. A water tank is provided on the upper portion of the bracket, the upper port of the water tank is communicated with the upper port of the collector, the lower port of the water tank is communicated with the lower port of the collector, the water is poured into the water tank, then a large-sized hollow ceramic solar plate water heater is formed.

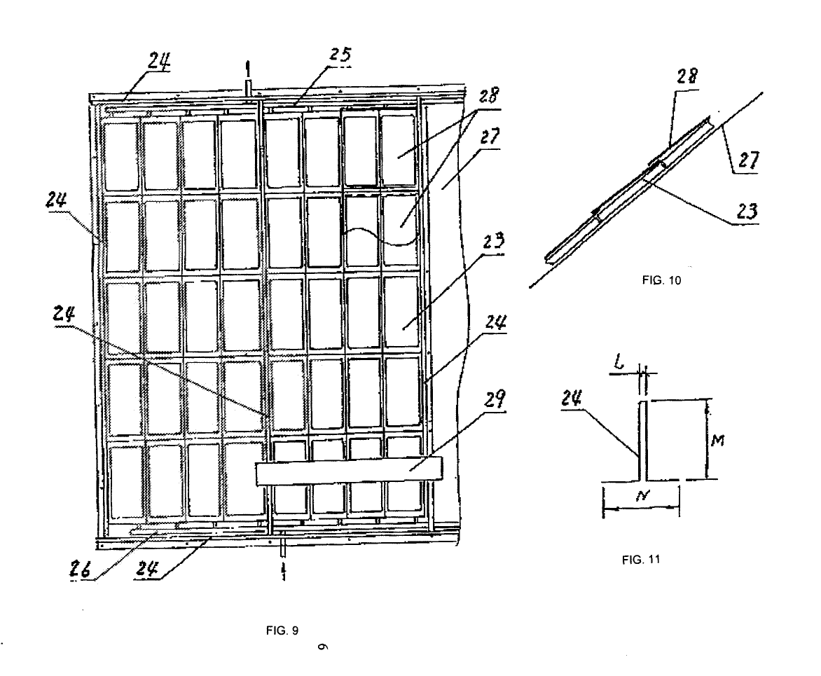

6. As shown in FIGS. 9-11, a vanadium-titanium black-porcelain solar roof system for home building is provided, the area of the solar roof facing south is 100 square meters located at the districts of 37 latitude, having a inclination of 30 degrees with horizontal plane. The roof structural layer is a grooved plate formed by a color steel plate with a thickness of 0.5 mm, a single grooved plate has a length of 8 m which is longitudinally installed. The flat groove bottom has a width of 740 mm, a standing side has a height of 120 mm. The vanadium-titanium black-porcelain compound ceramic solar plate has a length of 1500 mm, a width of 700 mm, a total thickness of 22 mm and a wall thickness of 2 mm, which is provided in the groove. A temperature preserving layer of a mixture of polyurethane foam plastic with a thickness of 30 mm and an expanded perlite with a thickness of 70 mm with cement is provided between the solar plate and the groove bottom, and a polyurethane foam plastic with a thickness of 20 mm is provided between the solar plate and the standing side, a flat glass with a thickness of 3 mm is adhered to the standing side by aging resistant and waterproof glue.

The ceramic water storage tank has a volume of 2500 liters which is provided on a weight bearing member of a building. In a sunny day in summer, the water temperature can reaches 80° C. or above. And the hot water with temperature of 80° C. drives a small absorbing type air conditioner, generating cold water with a temperature of 9° C. entering into a ceramic cold water storage tank. And cool wind with a temperature of 15° C. is transferred indoors after passing through a heat exchanger. The storage tanks are enveloped with insulating materials.

In winter, the water in the roof and the pipe is released. And the air in the sunlight plate is heated by sunlight. During daytime, the hot air passes through the spiral pipe in the water tank and forms a closed circulation with the air in the room. During nighttime, the indoor air forms a closed circulation with the spiral pipe in the water tank. And the residual heat in the water tank maintains the room at a certain temperature. When the ceramic solar roof is installed on the wall, a ceramic solar wall is formed.

In all seasons, the water in the ceramic water storage tank can provide daily hot water.

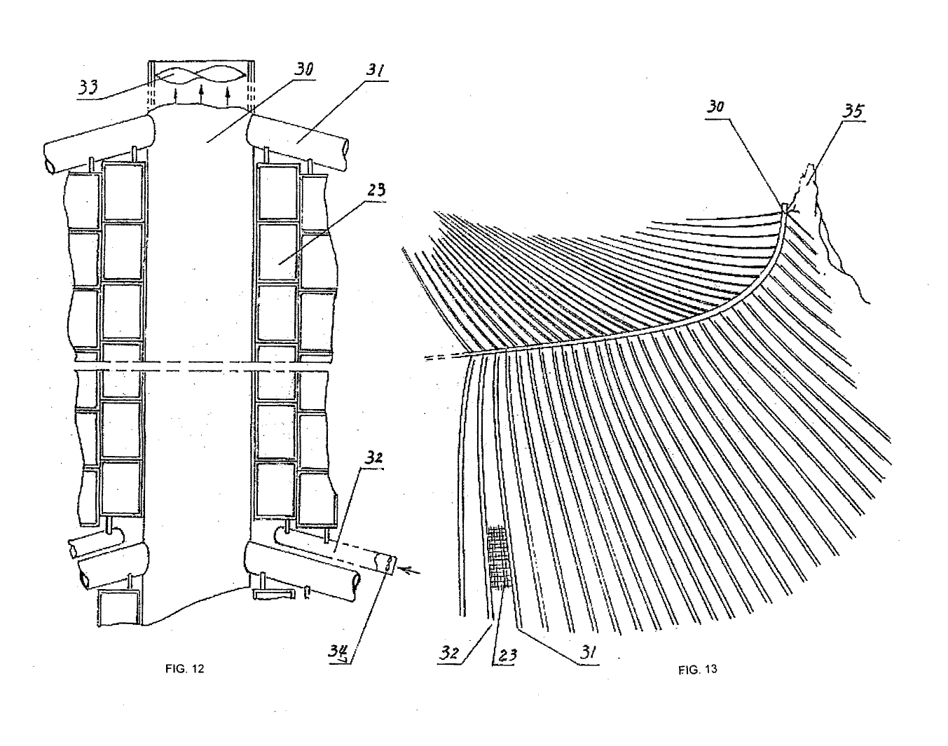

7. As shown in FIGS. 12 and 13, a ceramic solar wind duct is constructed at barren hills with plenty of sunlight and desolated beach at foot of the barren hills. The main wind duct 30 extends from the top of the hill peak to the desolated beach. The height difference between the desolated beach and the top of the hill peak is 1500 m. The main wind duct is constructed on upper portions of vertical and inclined hillside with a length of 5 km and constructed on a part of the desolated beach, which is substantially flat, with a length of 5 km, thus the total length of the wind duct is 10 km, so that the main wind duct constructed on the desolated beach inclines by 0.5˜2°. The exit portion of the main wind duct has the maximum diameter of 160 m which gradually tapers downwardly. At both sides of the main wind duct are connected with hot wind branch ducts 31 at intervals of 50 m for installing wind inlet pipes 32 each having a length of 5 km. The connecting point of the hot wind branch ducts and the main wind duct are highest, with the rear end inclining downwardly with an inclination of 0.1˜20. The diameter at the connecting point of the hot wind branch duct and the main wind duct is 8 m, which gradually tapers downwardly. And wind inlets pipes are constructed under a place which has a distance of 50 m in parallel to the hot wind branch duct. Both have similar lengths and inclinations, and the maximal portion of the wind inlet pipe has a diameter of 6 m. The longitudinal array of ceramic solar plate collectors 23 is provided between the hot wind branch duct and the wind inlet pipe. The connecting portion of the wind inlet pipe with the hot wind branch duct is higher than the wind inlet pipe with an inclination of 0.1˜2°. The longitudinal array of ceramic solar plate collectors which is soft connected by a large passage as shown in FIG. 8 is used, that is the large pipe port elastic hitching end-head plate made of silicone rubber, an elastic belt ring, a ceramic semi through hole plate, ceramic porous plate, ceramic semi through hole plate, porous plate with a length of 2000 mm, a width of 870 mm, a total thickness of 50 mm and a wall thickness of 3 mm are used, and the normal ceramic is used as the matrix with the surface being compounded with spatial reticular vanadium-titanium black-porcelain sunlight absorbing layer. And air turbine electric generation devices 33 are installed at entry port of the wind inlet pipe and the outlet port of the main wind duct.

8. The ceramic solar wind duct as said in embodiment 7, the wind inlet pipe is removed, and air turbine generation set is provided stage by stage in the hot wind branch ducts and the main wind duct.

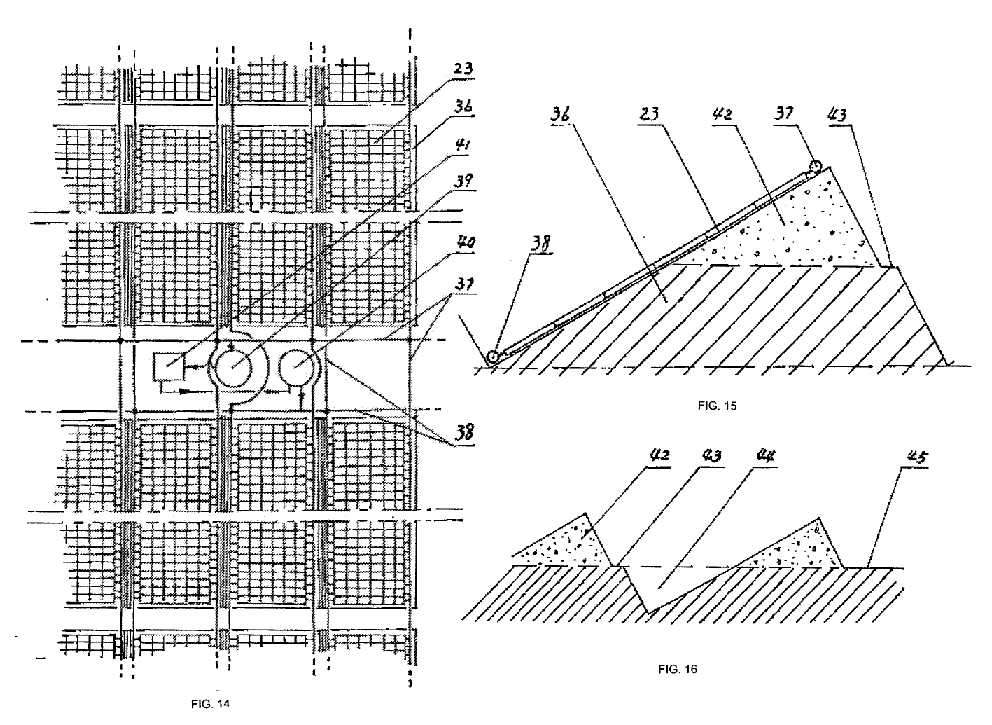

9. As shown in FIGS. 14-16, the hot water electric generation device of ceramic solar collecting field is constructed in desolated beach, desolated land and desert having plenty of sunlight. Windbreak is formed around the collecting field. And a first row of ditches are ditched along east-to-west direction by a ditcher, the ditch 44 has a length of 200 m per segment, and there are 100 segments all together having intervals of 5 m. The cross section of the ditch is an inverted triangle. The ditched out earth, stone and sand are put on the ground at a side of the slope facing south of the ditch, accumulating into inclining slopes 42 and forming south facing slopes with an inclination of 30° which are connected integrally with the slopes of the ditches. The slopes have inclined lengths of 10 m. And the slopes along the south-to-north direction are pressed flat and tamped tight. And a second row of ditches are formed at back of the south facing slopes which has a distance of 3 m from the accumulations. The horizontal duct has a width of 3 m, and ditches are formed in sequence in south-to-west direction, and there are 2000 rows of ditches. Concrete are poured along the tops and bottoms of the ditches with water pipes being laid. And mixture of expanded vermiculite and bond with thickness of 100 mm is covered on the south facing slopes. Hard polyurethane foam plastic with a thickness of 20 mm is sprayed. And there is a ridge protruding in south-to-north direction at an interval of 930 mm. The ridges have widths of 30 mm and heights of 100 mm, forming foam plastic groove frame. The groove bottom and the side thereof are placed with cotton felt of thick rock which has a thickness of 15 mm. An aging resistant polyurea coating layer is sprayed on the side of the ridge. And the longitudinal array of large passage combined type ceramic solar plates formed by gluing the large pipe port ceramic end-head plate, ceramic semi-through hole solar plate, ceramic porous solar plate and ceramic hitching joint using silicone rubber is installed in the groove frame. The upper and lower ports are communicated with the upper and lower pipes. The aging resistant bonding agent is coated on the top face of the groove frame. And a glass plate having a thickness of 4 mm is adhered to the top face of the ridge, thus forming the longitudinal array of ceramic solar collectors 23. The lower water pipe is communicated with the cold water tank 40, the upper water pipe is communicated with the hot water tank 39. And the water having a temperature of 80-100° C. heated by sunlight is used for generating electricity by “intermediate working medium method”.

10. The ceramic solar collecting field hot water electric generation device as said in embodiment 9, the hot water generates electricity by using “a decompressing and dilating method”.

11. The ceramic solar collecting field hot water electric generation device as said in embodiment 9, the hot water enters into a light converging solar device to be further heated into steam with high-temperature and high-pressure for generating electricity.

12. The ceramic solar collecting field hot water electric generation device as said in embodiment 9, the hot water tanks divided into high temperature hot water tanks and medium temperature hot water tanks. Due to various reasons, such as the weather is not good enough, the hot water of which the heated temperature does not reach the upper limit is stored in the medium-temperature hot water tanks. When the weather is good and the burning sun is shining, the hot water is heated again through the longitudinal array of solar plate collectors to the temperature upper limit and enters into the high-temperature hot water tanks for electric generation.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

1-12. (canceled)

13. A method for manufacturing a hollow black porcelain-ceramic plate, comprising:
preparing a ceramic pug;
producing a hollow ceramic plate bisque from the ceramic pug using a porous mold;
milling tailings of vanadium extraction or a mixture of tailings of vanadium extraction and ceramic raw material into a slurry of tailings of vanadium extraction;
covering a surface of the hollow ceramic plate bisque with the slurry of tailings of vanadium extraction; and
burning the hollow ceramic bisque plate covered with the slurry of the tailings of vanadium extraction into the hollow black porcelain-ceramic plate.

14. The method for manufacturing a hollow black porcelain-ceramic plate according to claim 13, wherein
the covering step includes spraying the slurry of tailings of vanadium extraction on the surface of the hollow ceramic plate bisque to produce a spatial reticular black-porcelain bisque layer on the surface of the hollow ceramic plate bisque; and
the burning step includes burning the hollow ceramic plate bisque covered with the spatial reticular black porcelain bisque layer into the hollow black porcelain-ceramic plate.

15. A hollow black porcelain-ceramic plate, comprising: a hollow porcelain-ceramic plate and a black porcelain layer integrally formed on a surface of the porcelain-ceramic plate and comprised of burned raw material of tailings of vanadium extractions or a mixture of the tailings of vanadium extraction and ceramic raw material.

16. The hollow black porcelain-ceramic plate according to claim 15, further including a heat preserving and insulating material on a bottom part of the hollow black porcelain-ceramic plate; and a transparent cover plate covering a top of the hollow black porcelain plate, wherein the hollow black porcelain-ceramic plate is useful as a ceramic solar collector.

17. A combination comprising a plurality of said hollow black porcelain-ceramic plates according to claim 16 connected in series to form a longitudinal array of ceramic solar collectors.

18. The hollow black porcelain-ceramic plate according to claim 15, and further including through holes in the hollow black porcelain-ceramic plate; an electric heating mechanism in the through holes; and heat preserving and insulating material at a bottom of the plate to produce a hollow black porcelain-ceramic plate which is useful as a ceramic far-infrared radiation plate.

19. The hollow black porcelain-ceramic plate according to claim 18, wherein the electric heating mechanism includes one of electric heating bodies in the through holes or high temperature air flow in the through holes.

20. The hollow black porcelain-ceramic plate according to claim 15, and further including through holes in the hollow black porcelain-ceramic plate; and entry and exits ports coupled to the through holes and adapted for mating with interfaces of a warming system, wherein the hollow black porcelain-ceramic plate is useful as a ceramic warming radiation plate.

21. The combination according to claim 17, wherein the longitudinal array of ceramic solar collectors is arranged on a roof for use as a ceramic solar roof.

22. The combination according to claim 17, wherein the longitudinal array of ceramic solar collectors is arranged on a wall facing south for use as a ceramic solar wall.

23. The combination according to claim 17, wherein a plurality of the longitudinal arrays of ceramic solar collectors are arranged in groups on a slope; the arrays each have through holes with lower ports and upper ports; and further including wind inlet pipes connected with the lower ports; hot wind branch ducts coupled to the upper ports; a main wind duct coupled to the hot wind branch ducts; a plurality of air turbines coupled to inlets of the wind inlet pipes and/or outlet ports of the main wind duct and/or hot wind branch ducts, wherein the air turbines are adapted to be connected to generators to form a solar wind duct electric generation device.

24. The combination according to claim 17, wherein a plurality of the longitudinal arrays of ceramic solar collectors are arranged in groups on a slope; the arrays each have though holes with lower ports and upper ports; and further including water inlet pipes coupled to the lower ports; water outlet pipes coupled to the upper ports; hot water tanks coupled to the water outlet pipes; and a hot water electric device coupled to the hot water tanks.
